(19) United States
(12) Patent Application Publication
(10) Pub. No.: US 2007/0190259 A1
(43) Pub. Date: Aug. 16, 2007

(54) Process for coating metallic surfaces with an aqueous composition, the aqueous composition and use of the coated substrates

(76) Inventors: Klaus Bittner, Frankfurt am Main (DE); Heribert Domes, Weilmunster (DE); Hardy Wietzoreck, Frankfurt am Main (DE); Christian Jung, Oberhaid (DE); Toshiaki Shimakura, Ichikawa-shi (JP)

Correspondence Address: FULBRIGHT & JAWORSKI, LLP, 666 FIFTH AVE, NEW YORK, NY, 10103-3198, US

(21) Appl. No.: 11/712,109

(22) Filed: Feb. 28, 2007

Related U.S. Application Data
(63) Continuation of application No. 10/362,626, filed on Sep. 10, 2003, now abandoned.

(30) Foreign Application Priority Data
Oct. 11, 2000 (DE) 100 50 532.5

(51) Int. Cl. B05D 7/00

(52) U.S. Cl. 427/407.1

(57) ABSTRACT

A composition and a method for coating a metallic surface with the composition, wherein the composition contains water, at least one organic film former containing a water-soluble polymer or a water-dispersible polymer; cations or a hexafluoro complex of cations of titanium, zirconium, hafnium, silicon, aluminum and boron; and at least one inorganic particle having an average particle diameter of 0.005 to 0.2 μm as measured with a scanning electron microscope by contacting a metallic surface with the composition and forming a film by drying, the film having a thickness of 0.01 to 10 μm.

The invention concerns a process for coating metallic surfaces with a composition containing a polymer, cations of titanium, zirconium, hafnium, silicon, aluminium or/and boron and fine inorganic particles. The invention also concerns a corresponding aqueous composition and the use of the substrates coated by the process according to the invention.

The most commonly used processes for the surface treatment of metals, in particular of metal strip, have until now been based upon the use of chromium(VI) compounds together with various auxiliary substances. Due to the toxicological and ecological risks inherent in such processes and moreover in view of the foreseeable legal restrictions on the use of chromate-containing processes, alternatives to these processes have long been sought in all areas of metal surface treatment.

EP-A-0 713 540,describes an acid, aqueous composition for the treatment of metal surfaces that contains complex fluoride based upon Ti, Zr, Hf, Si, Al or/and B, cations of Co, Mg, Mn, Zn, Ni, Sn, Cu, Zr, Fe or/and Sr, inorganic phosphates or phosphonates and polymers in a ratio of polymers to complex fluorides in the range from 1:2 to 3:1. In each example, however, this publication describes an addition of phosphate or phosphonate.

EP-A-0 181 377 or WO 85/05131 cites aqueous compositions based upon a) complex fluoride of B, Si, Ti or Zr, hydrofluoric acid or/and fluoride, b) salts of Co, Cu, Fe, Mn, Ni, Sr or/and Zn, c) a sequestering agent selected from nitrilotriacetic acid NTA, ethylene diamine tetraacetic acid EDTA, gluconic acid, citric acid or derivatives or alkali or ammonium salts thereof and d) a polymer of polyacrylic acid, polymethacrylic acid or C1 to C8 alkanol esters thereof. This publication does not teach the use of finely dispersed particles, however.

WO-A-93/20260 concerns a process for producing a coating for an aluminium-rich metallic surface with an aqueous mixture without phase separation containing complex fluoride based upon Ti, Zr, Hf, Si, Ge, Sn or/and B and a dissolved or/and dispersed compound based upon Ti, Zr, Hf, Al, Si, Ge, Sn or/and B. The specific polymer that is added is based upon 4-hydroxostyrene and phenolic resin and is yellowish and in some circumstances toxic in effect. It serves as a film former and bonding agent. The examples list aqueous compositions containing from 5.775 to 8.008 wt. % of hexafluorotitanic acid, SiO2 particles and this polymer. Moreover this publication protects a process for coating a metallic surface with this aqueous mixture first by contact and surface drying followed by brief contact with such a mixture at temperatures ranging from 25 to 90° C. The film thickness of the coating applied with this aqueous composition is not stated. However, this can be derived from the stated coating thicknesses of titanium that are applied, which range from 22 to 87 mg/m² and are therefore roughly ten times thicker than in the examples according to the invention in this application. This is congruent with the assumption that due to the high proportion of polymer in the suspension and due to the very high concentration of the suspension, the latter also displays an elevated viscosity, such that the suspension also forms a comparatively thick coating, which will probably be in the range of several μm in thickness. The T-bend data given for a 2-T bend after curing is not specifically comparable with the 1-T data in this application, but it can at any rate be judged to be clearly inferior, since the bend radius for 1-T is around 1 mm whereas for 2-T it is around 2 mm, as a consequence of which the stresses are significantly lower.

U.S. Pat. No. 5,089,064 teaches a process for coating aluminium-containing surfaces with an aqueous composition containing 0.01 to 18 wt. % hexafluorozirconic acid, 0.01 to 10 wt. % of a specific polymer based upon 4-hydroxystyrene and phenolic resin (see also WO-A-93/20260), 0.05 to 10 wt. % SiO2 particles, optionally a solvent to dissolve 4-hydroxystyrene-phenolic resin below 50° C. and optionally a surfactant, the aqueous composition being applied in a surface drying process with no subsequent rinsing.

WO96/07772 describes a process for the conversion treatment of metallic surfaces with an aqueous composition containing (A) complex fluorides based upon Ti, Zr, Hf, Si, Al or/and B of at least 0.15 M/kg, (B) cations selected from Co, Cu, Fe, Mg, Mn, Ni, Sn, Sr, Zn or/and Zr with a molar ratio of (B) to (A) in the range from 1:5 to 3:1, (C) at least 0.15 Mp/kg of phosphorus-containing oxyanions or/and phosphonates, (D) at least 1% of water-soluble and water-dispersible polymers or of polymer-forming resins and (E) sufficient free acid to give the aqueous composition a pH in the range from 0.5 to 5.

The object of the invention is to overcome the disadvantages of the prior art and in particular to propose a process for coating metallic surfaces that is also suitable for high coating speeds such as are used for strips, that is largely or entirely free from chromium (VI) compounds and can be used on an industrial scale.

The object is achieved by a process for coating a metallic surface, in particular aluminium, iron, copper, magnesium, nickel, titanium, tin, zinc or alloys containing aluminium, iron, copper, magnesium, nickel, titanium, tin or/and zinc with an aqueous composition that is largely or entirely free from chromium (VI) compounds as a pretreatment prior to an additional coating or as a treatment, the article to be coated—in particular a strip or section of strip—being optionally formed after being coated, characterised in that the composition contains in addition to water

a) at least one organic film former containing at least one polymer that is soluble in water or dispersed in water,

b) a content of cations or/and hexafluoro or tetrafluoro complexes of cations selected from the group comprising titanium, zirconium, hafnium, silicon, aluminium and boron,

c) at least one inorganic compound in particle form with an average particle diameter measured with a scanning electron microscope ranging from 0.005 to 0.2 μm in diameter,

d) optionally at least one silane or/and siloxane calculated as silane and

e) optionally a corrosion inhibitor,

the clean metallic surface being brought into contact with the aqueous composition and a particle-containing film is formed on the metallic surface, which is then dried and optionally additionally cured,

whereby the dried and optionally also cured film displays a film thickness in the range from 0.01 to 10 μm—determined on an approximate basis from the constituents, the density of the constituents and the amounts of titanium or zirconium applied to the coated surface determined by X-ray fluorescence analysis.

A standard coil-coating lacquer F2-647 together with the topcoat lacquer F5-618 applied to the dried or cured film preferably results in an adhesive strength of a maximum of 10% of the surface peeled away in a T-bend test with a 1-T bend according to NCCA.

Both are lacquers produced by Akzo Nobel. The primer coating for these tests is applied to the coating according to the invention in a reasonably exact standard film thickness of 5 μm and the topcoat lacquer is applied to this primer coat in a reasonably exact standard film thickness of 20 μm. A section of coated strip is then bent over until at the bending point the distance between the two halves of metal sheet is exactly the thickness of the metal sheet. The sheet thickness of the material used was 0.8 mm. The lacquer adhesion at the bending point was then tested by adhesive tape testing and the percentage of surface peeled away stated as the result of the test. The T-bend test can therefore be regarded as a very demanding lacquer adhesion test for the quality of pretreated and lacquered metallic sheets in terms of the damage to this coating system during subsequent forming. The proportions of the surface peeled away in the T-bend test are preferably up to 8%, particularly preferably up to 5%, most particularly preferably up to 2%, the best values however being virtually 0%, such that then only cracks but no peeling can conventionally occur.

The organic film former is preferably contained in the aqueous composition (=bath solution) in an amount from 0.1 to 100 g/l, particularly preferably in a range from 0.2 to 30 g/l, most particularly preferably 0.5 to 10 g/l, in particular 1 to 4 g/l.

The content of cations or/and hexafluoro complexes of cations selected from the group comprising titanium, zirconium, hafnium, silicon, aluminium and boron in the aqueous composition (bath solution) is preferably 0.1 to 50 g/l, particularly preferably 0.2 to 30 g/l, most particularly preferably 0.5 to 10 g/l, in particular 1 to 4 g/l. These figures relate to the content of elemental metal.

The inorganic compound in particle form is preferably contained in the aqueous composition (bath solution) in an amount from 0.1 to 80 g/l, particularly preferably in a range from 0.2 to 25 g/l, most particularly preferably 0.5 to 10 g/l, in particular 1 to 4 g/l.

The ratio of the contents of cations or/and hexafluoro complexes of cations selected from the group comprising titanium, zirconium, hafnium, silicon, aluminium and boron to the contents of organic film former in the aqueous composition (bath solution) can vary widely; in particular it can be ≦1:1. This ratio is preferably in a range from 0.05:1 to 3.5:1, particularly preferably in a range from 0.2:1 to 2.5:1.

The ratio of the contents of cations or/and hexafluoro complexes of cations selected from the group comprising titanium, zirconium, hafnium, silicon, aluminium and boron to the contents of inorganic compounds in particle form in the aqueous composition (bath solution) can vary widely; in particular it can be ≦5.5:1. This ratio is preferably in a range from 0.05:1 to 5:1, particularly preferably in a range from 0.2:1 to 2.5:1.

The ratio of the contents of organic film former to the contents of inorganic compounds in particle form in the aqueous composition (bath solution) can vary widely; in particular it can be ≦3.8:1. This ratio is preferably in a range from 0.05:1 to 3.5:1, particularly preferably in a range from 0.18:1 to 2.5:1.

The content of at least one silane or/and siloxane calculated as silane in the aqueous composition (bath solution) is preferably 0.1 to 50 g/l, particularly preferably 0.2 to 35 g/l, most particularly preferably 0.5 to 20 g/l, in particular 1 to 10 g/l. Such an addition can help to improve the adhesion of a subsequently applied organic coating through reactive functional groups such as amino or epoxy functions.

The aqueous composition is preferably also free or largely free from transition metals or heavy metals other than those present in the inorganic compound in particle form in very small particle sizes or/and bonded to fluorine e.g. as hexafluoride or/and tetrafluoride, in which case they are also then not necessarily bonded only to fluorine, however. The aqueous composition can moreover also be free or largely free from transition metals or heavy metals that have deliberately been added to the aqueous composition, with the exception of the aforementioned additives in particle form and with the exception of the compounds that are at least partially bonded to fluoride. On the other hand the aqueous composition can display traces or small amounts of impurities in the form of transition metals or heavy metals that have been released from the metallic substrate surface or/and from the bath containers or pipes as a result of a pickling effect, that have been carried over from previous baths or/and that originate from impurities in the raw materials. The aqueous composition is particularly preferably free or largely free from lead, cadmium, iron, cobalt, copper, manganese, nickel, zinc or/and tin. Above all the use of largely or entirely chromium-free aqueous compositions is recommended. The aqueous composition that is largely free from chromium (VI) compounds displays a chromium content of only up to 0.05 wt. % on chromium-free metallic surfaces and a chromium content of up to 0.2 wt. % on chromium-containing metallic surfaces. The aqueous composition is preferably also free from phosphorus-containing compounds unless these are bonded to the polymer or are intended to be bonded to it to a great extent. It is preferable for neither chromium, phosphate or phosphonate nor amounts of lead, cadmium, iron, cobalt, copper, manganese, nickel, zinc or/and tin to be added intentionally, such that corresponding contents can only arise as a result of trace impurities, drag-in from previous baths or pipes or as a result of the partial dissolution of compounds in the surface to be coated. The composition is preferably also free from additions or contents of hydroxocarboxylic acids such as e.g. gluconic acid.

The term “clean metallic surface” in this context means an uncleaned metallic, e.g. freshly galvanised surface that requires no cleaning, or a freshly cleaned metallic surface.

In the process according to the invention the organic film former can be in the form of a solution, dispersion, emulsion, micro-emulsion or/and suspension. The organic film former can be or contain at least one synthetic resin, in particular a synthetic resin based upon acrylate, polyacrylic, ethylene, polyethylene, polyester, polyurethane, silicone polyester, epoxy, phenol, polystyrene, styrene, urea-formaldehyde, mixtures thereof or/and mixed polymers thereof. It can be a cationically, anionically or/and sterically stabilised synthetic resin or polymer or/and solution thereof.

The organic film former is preferably a synthetic resin blend or/and a mixed polymer that contains an amount of synthetic resin based upon acrylate, polyacrylic, ethylene, polyethylene, urea-formaldehyde, polyester, polyurethane, polystyrene or/and styrene, from which during or after the release of water and other volatile components an organic film is formed. The organic film former can contain synthetic resin or/and polymer based upon polyacrylate, polethyleneimine, polyurethane, polyvinyl alcohol, polyvinyl phenol, polyvinyl pyrrolidone, polyaspartic acid or/and derivatives or copolymers thereof, in particular copolymers with a phosphorus-containing vinyl compound, ethylene-acrylic mixed polymer, acrylic-modified polyester, acrylic-polyester-polyurethane mixed polymer or styrene acrylate. The synthetic resin or polymer is preferably water-soluble. It preferably contains free acid groups that are non-neutralised, to allow an attack on the metallic surface.

A synthetic resin based upon polyacrylic acid, polyacrylate or/and polyethylene acrylic acid is most particularly preferred, in particular the last of these as a copolymer, or a synthetic resin with a melting point ranging from 40 to 160° C., in particular ranging from 120 to 150° C. The acid value of the synthetic resin can preferably be in the range from 5 to 800, particularly preferably in the range from 50 to 700. In most cases the advantage of such synthetic resins lies in the fact that these synthetic resins or polymers do not need to be stabilised cationically, anionically or sterically. The molecular weight of the synthetic resin or polymer can be in the range of at least 1000 u, preferably from 5000 to 250,000 u, particularly preferably in the range from 20,000 to 200,000 u.

The phosphorus content in the aqueous composition is preferably largely or entirely bonded to organic, in particular polymeric, compounds, such that none or almost none of the phosphorus content is bonded to purely inorganic compounds such as e.g. orthophosphates.

On the one hand the aqueous composition can be such that it contains no corrosion inhibitors, the coatings that are formed from it already acquiring outstanding corrosion protection. On the other hand it can also display a content of at least one corrosion inhibitor. The corrosion inhibitor can display at least one organic group or/and at least one amino group. It can contain an organic compound or an ammonium compound, in particular an amine or an amino compound, such as e.g. an alkanolamine, a TPA-amine complex, a phosphonate, a polyaspartic acid, a thio urea, a Zr ammonium carbonate, benzotriazole, a tannin, an electrically conductive polymer such as e.g. a polyaniline or/and derivatives thereof, as a result of which the corrosion protection can again be significantly improved. It can be advantageous if the corrosion inhibitor is readily soluble in water or/and readily dispersible in water, in particular in an amount of more than 20 g/l. It is preferably contained in the aqueous composition in an amount ranging from 0.01 to 50 g/l, particularly preferably ranging from 0.3 to 20 g/l, most particularly preferably ranging from 0.5 to 10 g/l. An addition of at least one corrosion inhibitor is particularly important for electrogalvanised steel sheets. The addition of a corrosion inhibitor can help to achieve the required reliability for corrosion resistance in mass production.

It was further found that an addition of manganese ions, e.g. added as a metal in acid solution or in the form of manganese carbonate, to the compositions listed in the examples improved resistance to alkalis. In particular, an addition of Mn ions in an amount ranging from 0.05 to 10 g/l has proven to be very effective. Surprisingly this addition of manganese resulted in a noticeable improvement not only in alkali resistance but also in general corrosion resistance and lacquer adhesion.

In the process according to the invention the pH of the aqueous solution of the organic film former without addition of other compounds is preferably in the range from 0.5 to 12, in particular below 7, particularly preferably in the range from 1 to 6 or 6 to 10.5, most particularly preferably in the range from 1.5 to 4 or 7 to 9, depending on whether the process is performed in the acid or more basic region. The pH of the organic film former alone in an aqueous preparation without addition of other compounds is preferably in the range from 1 to 12.

It is also preferable for the aqueous, fluorine-containing composition to contain a high or very high proportion of complex fluoride, in particular 50 to 100 wt. % relative to the fluorine content. The content of fluorine in the form of complexes and free ions in the aqueous composition (bath solution) is preferably in total 0.1 to 14 g/l, preferably 0.15 to 8 g/l, in particular 0.2 to 3 g/l.

On the other hand it is preferable for the aqueous composition to include an amount of zirconium as the sole cation or in a fairly high proportion, i.e. at least 30 wt. %, relative to the mixture of cations selected from the group comprising titanium, zirconium, hafnium, silicon, aluminium and boron. The content of such cations in the aqueous solution (bath solution) is preferably in total 0.1 to 15 g/l, preferably 0.15 to 8 g/l, in particular 0.2 to 3 g/l. The content of zirconium or/and titanium in the aqueous composition is preferably in total 0.1 to 10 g/l, particularly preferably 0.15 to 6 g/l, in particular 0.2 to 2 g/l. It has been found that none of the cations selected from this group produces better results in terms of corrosion protection and lacquer adhesion than zirconium included as a proportion of these cations or selected on its own.

If a clear excess of fluoride is present relative to the content of such cations, in particular more than 35 mg/l of free fluoride, then the pickling effect of the aqueous composition is strengthened. A content of 35 to 350 mg/l of free fluoride can in particular help to provide better control of the thickness of the coating that is produced. If significantly less fluoride is present relative to the content of such cations, then the pickling effect of the aqueous composition is significantly reduced and a thicker coating is commonly formed, which in some cases can even be too thick and can easily be subject to filiform corrosion and in addition displays inferior lacquer adhesion.

The coating that is formed can be a conversion coating or a coating that does not dissolve out and incorporate any of the elements contained in the metallic surface. The coating is preferably applied to the ultra-thin oxide/hydroxide layer lying directly on the metallic surface or even directly to the metallic surface. Depending on whether a thick or thin film is required, a higher or lower concentration of cations from the aforementioned group or fluoride is needed.

Particularly good coating results were obtained with a liquid film in the range from 0.8 to 12 ml/m², in particular with a liquid film of approximately 2 ml/m² applied using the no-rinse method (surface drying method with no subsequent rinsing step) with a production rollcoater or with a liquid film of approximately 7 ml/m² applied using the no-rinse method with a laboratory rollcoater. With roller application a thicker liquid film is often applied (conventionally in the range from 2 to 10 ml/m²) than is the case with immersion and squeezing with smooth rubber rollers (conventionally in the range from 1 to 6 ml/m²)

For a concentrate to prepare the bath solution initially by dilution with water or for a top-up solution to adjust the bath solution if the bath is used for extended periods, aqueous compositions are preferably used that contain most or almost all constituents of the bath solution, but not the at least one inorganic compound in particle form, which is preferably kept separate and added separately. Furthermore, the addition of at least one accelerator, such as is conventionally used during phosphating, can also be advantageous here too, because it allows an accelerated attack on the metallic surface by accelerating the oxidative dissolution of the metal or alloy. Suitable examples include at least one peroxide or/and at least one compound based on hydroxylamine, nitroguanidine or nitrate. The concentrate or top-up solution preferably displays a concentration that is five to ten times more highly concentrated than the bath solution, in terms of the individual constituents.

The organic film former can also be composed in such a way that it contains (only) water-soluble synthetic resin or/and polymer, in particular one that is stable in solutions with pH values ≦5.

The organic film former preferably contains synthetic resin or polymer that displays an elevated content of carboxyl groups. On the other hand synthetic resins that only become water-soluble or water-dispersible after reaction with a basic compound such as ammonia, amines or/and alkali metal compounds can also be used.

In the process according to the invention it can be preferable for the aqueous composition to contain at least one partially hydrolysed or entirely hydrolysed silane. It then offers the advantage that improved adhesion is obtained in many lacquer. systems. The silane can be an acyloxysilane, an alkyl silane, an alkyl trialkoxysilane, an aminosilane, an aminoalkyl silane, an aminopropyl trialkoxysilane, a bis-silyl silane, an epoxy silane, a fluoroalkyl silane, a glycidoxysilane such as e.g. a glycidoxyalkyl trialkoxysilane, an isocyanato silane, a mercapto silane, a (meth)acrylato silane, a monosilyl silane, a multisilyl silane, a bis-(trialkoxysilylpropyl) amine, a bis-(trialkoxysilyl) ethane, a sulfur-containing silane, a bis-(trialkoxysilyl) propyl tetrasulfane, a ureidosilane such as e.g. a (ureidopropyl trialkoxy)silane or/and a vinyl silane, in particular a vinyl trialkoxysilane or/and a vinyl triacetoxysilane. At least one silane can for example be mixed with a content of at least one alcohol such as ethanol, methanol or/and propanol of up to 8 wt. % relative to the silane content, preferably up to 5 wt. %, particularly preferably up to 1 wt. %, most particularly preferably up to 0.5 wt. %, optionally with a content of inorganic particles, in particular in a mixture consisting of at least one amino silane such as e.g. bis-amino silane with at least one alkoxy silane such as e.g. trialkoxysilylpropyl tetrasulfane or a vinyl silane and a bis-silyl aminosilane or a bis-silyl polysulfur silane and/or a bis-silyl amino silane or an amino silane and a multisilyl-functional silane. The aqueous composition can then also alternatively or additionally contain at least one siloxane corresponding to the aforementioned silanes. Silanes/siloxanes displaying a chain length in the range from 2 to 5 C atoms and displaying a functional group that is suitable for reacting with polymers are preferred. An addition of at least one silane or/and siloxane can be favourable for forming bonding bridges or for promoting crosslinking.

In the process according to the invention, a finely dispersed powder, a dispersion or a suspension, such as e.g. a carbonate, an oxide, a silicate or a sulfate, in particular colloidal or amorphous particles, is added as the inorganic compound in particle form. Particles based upon at least one compound of aluminium, barium, cerium, calcium, lanthanum, silicon, titanium, yttrium, zinc or/and zirconium are particularly preferred as the inorganic compound in particle form, in particular particles based upon aluminium oxide, barium sulfate, cerium dioxide, rare-earth mixed oxide, silicon dioxide, silicate, titanium oxide, yttrium oxide, zinc oxide or/and zirconium oxide. The at least one inorganic compound in particle form is preferably in the form of particles having an average particle size ranging from 6 nm to 150 nm, particularly preferably ranging from 7 to 120 nm, most particularly preferably ranging from 8 to 90 nm, even more preferably ranging from 8 to 60 nm, most preferably of all ranging from 10 to 25 nm. Larger particles preferably have a rather platelet-shaped or elongated particle shape.

If metallic substrates coated according to the invention and optionally provided with lacquer or lacquer-like coatings are to be welded, it can be advantageous if as particles of the compound in particle form examples having elevated or high electrical conductivity are used, in particular particles of oxides, phosphates, phosphides or sulfides of aluminium, iron or molybdenum, in particular aluminium phosphide, iron oxide, iron phosphide, at least one molybdenum compound such as molybdenum sulfide, graphite or/and carbon black, wherein these particles can then also display an average particle size such that they optionally project rather further from the coating according to the invention.

At least one organic solvent can also be added in the process according to the invention. At least one water-miscible or/and water-soluble alcohol, a glycol ether or N-methyl pyrrolidone or/and water can be used as the organic solvent for the organic polymers and, if a solvent blend is used, in particular a mixture of water and at least one long-chain alcohol, such as e.g. propylene glycol, an ester alcohol, a glycol ether or/and butanediol. In many cases, however, preferably only water is added with no organic solvent. The content of organic solvent, if added at all, is preferably 0.1 to 10 wt. %, in particular 0.2 to 5 wt. %, most particularly 0.4 to 3 wt. %. For metal strip production it is preferable to use only water with no organic solvents, other than possibly small amounts of alcohol such as e.g. up to 3 wt. %.

In the process according to the invention at least one wax selected from the group comprising paraffins, polyethylenes and polypropylenes can be added as lubricant, in particular an oxidised wax or a HD polyethylene. It is particularly advantageous to add the wax as an aqueous or anionically or cationically stabilised dispersion, because it can then be kept readily homogeneously dispersed in the aqueous composition. The melting point of the wax used as lubricant is preferably in the range from 40 to 160° C., in particular in the range from 120 to 150° C. It is particularly advantageous to add, in addition to a lubricant with a melting point in the range from 120 to 165° C., a lubricant with a melting point in the range from 45 to 95° C. or with a glass transition temperature in the range from −20 to +60° C., in particular in quantities of 2 to 30 wt. %, preferably 5 to 20 wt. %, of the total solids content. This last lubricant can also advantageously be used by itself. A wax content is only advantageous however if the coating according to the invention is a treatment coating or if the wax content in a pretreatment coating should not have a disadvantageous effect on the subsequent lacquer finish.

The acid groups in the synthetic resin or/and the polymer can be neutralised with ammonia, with amines such as e.g. morpholine, dimethyl ethanolamine, diethyl ethanolamine or triethanolamine or/and with alkali-metal compounds such as e.g. sodium hydroxide.

The aqueous composition is preferably free from inorganic or organic acids, optionally with the exception of hexafluoro acids.

Furthermore, a basic compound can be added to the aqueous composition to keep the aqueous composition at a pH in the range from 0.5 to 5. Bases selected from ammonia and amine compounds, such as e.g. triethanolamine, are particularly preferred.

The aqueous composition can optionally contain at least one each of a biocide, a defoaming agent, a bonding agent, a catalyst, a corrosion inhibitor, a wetting agent or/and a forming additive. Some additives exhibit multiple functions; thus many corrosion inhibitors for example are also bonding agents and possibly also wetting agents.

The water content of the aqueous composition can vary widely. Its water content will preferably be in the range from 95 to 99.7 wt. %, in particular in the range from 97.5 to 99.5 wt. %, wherein a small part of the water content stated here can also be replaced by at least one organic solvent. In high-speed strip plants the content of water or optionally of water together with a small content (up to 3 wt. %) of organic solvent is preferably in the range from 97 to 99 wt. %, particularly preferably in the range from 97.5 to 98.5 wt. %. If water is added to the aqueous composition, demineralised water or another somewhat purer quality of water is preferably added.

In the process according to the invention the aqueous composition can be applied by rolling, flow-coating, knife application, spraying, atomisation, brushing or/and immersion and optionally by subsequent squeezing e.g. with a roller.

The aqueous composition can display a pH in the range from 0.5 to 12, preferably in the range from 1 to 6 or 7 to 9, most particularly preferably in the range from 1.5 to 4 or 6 to 10.5, depending on whether the process is performed in the acid or more basic region.

The aqueous composition can be applied to the metallic surface in particular at a temperature in the range from 5 to 50° C., preferably in the range from 10 to 40° C., particularly preferably in the range from 18 to 25° C.

In the process according to the invention the metallic surface can be kept at temperatures in the range from 5 to 120° C., preferably in the range from 10 to 60° C., most preferably from 18 to 25° C. during application of the coating.

Final drying in the case of such films can last for many days, whereas substantial drying can be completed in just a few seconds. Film formation occurs above all with drying in the temperature range from 25 to 95° C., optionally also at even higher temperature. In some circumstances curing can last for several weeks until the final drying or curing state is reached. In such cases thermal crosslinking will play little or no part in the polymerisation process or the proportion of polymerisation will be correspondingly low. Following such film forming and curing, the coating according to the invention can be regarded as an anti-corrosive coating, in particular as a treatment or pretreatment coating.

If necessary, the curing state can additionally be accelerated or strengthened by chemical or/and thermal acceleration of crosslinking, in particular by heating, or/and by actinic irradiation e.g. with UV radiation, suitable synthetic resins/polymers and optionally photoinitiators then being added. With appropriate additions or process variants a partial, extensive or complete crosslinking of the polymers can be achieved. The coating according to the invention that has been crosslinked in this way can be regarded and used as an anti-corrosive coating if it contains small amounts of polymers (in particular 0.05 to 5 wt. % of polymers in the aqueous composition) and as a primer coating, in particular as a pretreatment primer coating, if it contains larger amounts of polymers (0.5 to 50 wt. % of polymers in the aqueous composition).

The coated metallic surface can further be dried at a temperature in the range from 20 to 250° C., preferably in the range from 40 to 120° C., most particularly preferably at 60 to 100° C. PMT (peak metal temperature). The residence time that is required for drying is substantially inversely proportional to the drying temperature: e.g. in the case of material in strip form 1 s at 100° C. or 30 min at 20° C., whereas coated parts need to be dried for significantly longer, depending inter alia upon wall thickness. Drying installations based in particular on circulating air, induction, infrared or/and microwaves are suitable for drying.

The film thickness of the coating according to the invention is preferably in the range from 0.01 to 6 μm, particularly preferably in the range from 0.02 to 2.5 μm, most particularly preferably in the range from 0.03 to 1.5 μm, in particular in the range from 0.05 to 0.5 μm. For the coating of metal strips the coated strips can be wound into a coil, optionally after cooling to a temperature in the range from 40 to 70° C.

The coating according to the invention does not have to be the only treatment/pretreatment coating applied to the metallic surface; instead it can also be a treatment/pretreatment coating under two, three or even four different treatment/pretreatment coatings. For example, it can be applied as the second layer in a system comprising at least two such layers, e.g. after alkaline passivation based for example on Co—Fe cations. It can also be applied as the third layer, for example, in a system comprising three such layers, e.g. after an activation treatment on the basis of e.g. titanium and after a pretreatment coating e.g. with a phosphate such as ZnMnNi phosphate. Furthermore, many other combinations with similar or different treatment/pretreatment coatings are also conceivable and very suitable in such a coating system. The choice of types and combinations of such coatings together with the coating according to the invention is above all a question of the individual application, requirements and justifiable costs.

If required, at least one lacquer or/and at least one lacquer-like coating, such as e.g. firstly a primer, can then be applied to the coating according to the invention or to the topmost treatment/pretreatment coating in such a coating system. Either a lacquer or a lacquer-like interlayer or the remaining lacquer sequence, comprising e.g. filler and at least one topcoat, can then be applied to the primer coating if required. Within the context of this application a lacquer-like coating is also referred to as a coating consisting of a “lacquer”.

At least one coating consisting of a lacquer, polymer, paint, adhesive or/and adhesive support can be applied to the partially or wholly dried or cured film, for example also a special coating such as e.g. a coating with the ability to reflect IR radiation.

The metal parts, in particular strips or sections of strip, coated according to the invention with the aqueous composition can be formed, lacquered, coated with polymers such as e.g. PVC, printed, glued, hot-soldered, welded or/and joined to one another or to other elements by clinching or by other joining methods. Forming does not conventionally take place until after lacquering, however. These processes are known in principle.

The object is also achieved by an aqueous composition for the pretreatment of a metallic surface prior to an additional coating or for the treatment of that surface, which is characterised in that the composition contains in addition to water

a) at least one organic film former containing at least one polymer that is soluble in water or dispersed in water,

b) a content of cations or/and hexafluoro complexes of cations selected from the group comprising titanium, zirconium, hafnium, silicon, aluminium and boron,

c) at least one inorganic compound in particle form with an average particle diameter measured with a scanning electron microscope ranging from 5 nm to 0.1 μm in diameter,

d) optionally at least one silane or/and siloxane calculated as silane and

e) optionally at least one corrosion inhibitor.

The part having a metallic surface that is coated according to the invention with the aqueous composition can be a wire, a wire winding, a wire mesh, a steel strip, a metal sheet, a panel, a screen, a vehicle body or part of a vehicle body, a part of a vehicle, trailer, motor caravan or airborne vehicle, a cover, a housing, a lamp, a light, a traffic signal element, a piece of furniture or furniture element, an element of a household appliance, a frame, a profile, a moulding with a complex geometry, a crash barrier, heater or fencing element, a bumper, a part comprising or with at least one pipe or/and profile, a window, door or bicycle frame, or a small part such as e.g. a screw, nut, flange, spring or spectacle frame.

The process according to the invention represents an alternative to the cited chromate-containing processes, in particular in the area of surface pretreatment of metal strip prior to lacquering, and in comparison to them it delivers similarly good results with regard to corrosion protection and lacquer adhesion.

Furthermore, the process according to the invention can be used to treat the metal surface cleaned by conventional means without a subsequent aftertreatment such as rinsing with water or a suitable rinsing solution. The process according to the invention is suitable in particular for application of the treatment solution by means of a so-called rollcoater, whereby the treatment liquid can be dried immediately after application without any subsequent process steps such as e.g. rinsing steps (dry-in-place technology). This simplifies the process considerably in comparison to conventional spraying or immersion processes, for example, and only the smallest amounts of waste-water are produced because squeezing with a roller means that virtually no bath liquid is lost without being used, which also represents an advantage over the already established chromium-free processes used in the spraying process with rinsing solutions.

The coatings according to the invention can be used to obtain pretreatment coatings that together with the subsequently applied lacquer produced a coating system that is equivalent to the best chromium-containing coating systems.

The coatings according to the invention are conventionally far thinner than 0.5 μm. The thicker the coatings, the greater the reduction in lacquer adhesion, although corrosion protection is possibly slightly further improved.

The coatings according to the invention are very inexpensive and environmentally friendly and can readily be used on an industrial scale.

It was surprising that with a synthetic resin coating according to the invention, despite a film thickness of only approx. 0.05 or 0.2 μm, an extraordinarily high-quality chromium-free film could be produced that provides an extraordinarily good lacquer adhesion on the coating according to the invention. It was further surprising that the addition of finely divided particles produced a significant improvement in lacquer adhesion,—an improvement in corrosion resistance could be hoped for with the inclusion of inorganic particles but an improvement in lacquer adhesion was not foreseeable.

### EXAMPLES

The examples described below are intended to explain the subject of the invention in greater detail. The stated concentrations and compositions relate to the treatment solution itself and not to any feedstock solutions of a higher concentration that may be used. All stated concentrations should be understood to be solids contents, i.e. the concentrations relate to the amounts by weight of the active components, regardless of whether the raw materials used are included in diluted form, e.g. as aqueous solutions. The surface treatment of the test sheets was always conducted in the same way and in detail comprised the following steps:
I. alkaline cleaning by spraying with Gardoclean® S5160
II. rinsing with water
III. rinsing with demineralised water
IV. application of the treatment solutions according to the invention using a Chemcoater
V. drying in a circulating air oven (PMT: 60 to 80° C.)
VI. coating of the pretreated surfaces with coil coating lacquer systems (primer and topcoat).

A polyethylene-acrylate copolymer with an acid value of around 30 and with a melting range at a temperature in the range from 65 to 90° C. was chosen for the tests. The polyacrylic acid-vinyl phosphonate copolymer used displayed an acid value of around 620 and its 5% aqueous solution a pH of reasonably exactly 2.0. Technically pure polyacrylic acid with an acid value of around 670 and with a molecular weight of around 100,000 u was used as the polyacrylic acid. In the case of the silanes used, technically pure compounds were added that were hydrolysed in the aqueous composition and that in particular were reacted to siloxanes by drying and curing.

All examples according to the invention were prepared without addition of an organic solvent. In individual examples, e.g. in examples 1 to 4 and 8 to 10 and in example 15, the pH was adjusted to the value shown in Table 1 by addition of ammonia. Otherwise no additives other than those listed in the examples were added. Small amounts of additives may have been added by the raw material manufacturer, however. The residual content to 100 wt. % or to 1000 g/l gives the water content.

The individual components could generally be mixed together in any sequence. When adding manganese carbonate, zirconium ammonium carbonate or aluminium hydroxide, however, care must be taken to ensure that these substances are first dissolved in the concentrated acid components before the main amount of water is added. When adding aluminium hydroxide or manganese carbonate, care must be taken to ensure that these substances are completely dissolved in the aqueous composition.

### Example 1

### According to the Invention

Metal sheets obtained from commercial cold-rolled steel strip were first degreased in an alkaline spray cleaner and then treated with the aqueous composition according to the invention. A defined amount of the treatment solution was applied such that a wet film thickness of approx. 6 ml/m² was obtained. The treatment solution contained, in addition to water and fluoro complexes of titanium and zirconium, water-soluble copolymers based on acrylate and an organic phosphorus-containing acid together with an aqueous dispersion of inorganic particles in the form of pyrogenic silica. The solution had the following composition:

1.6 g/l hexafluorozirconic acid

0.8 g/l hexafluorotitanic acid

2 g/l polyacrylic acid-vinyl phosphonate copolymer

2 g/l SiO₂ (as pyrogenic silica)

1 g/l citric acid

The silica dispersion contained particles having an average particle diameter measured by scanning electron microscopy in the range from approximately 20 to 50 nm. The components were mixed in the stated sequence and the pH of the solution then adjusted to 4.5 with a fluoride-containing ammonia solution. The aqueous composition contained 3.4 g/l acids, 4 g/l solids and otherwise only water. After application the solution was dried in a circulating air oven at approx. 70 OC PMT (peak metal temperature). The steel sheets pretreated in this way were coated with a commercial chromium-free coil-coating lacquer system.

### Example 2

### According to the Invention

Steel sheets were treated as described in Example 1, but with a composition containing only titanium as transition metal and the inorganic particles in the form of an aqueous colloidal silica dispersion:

2 g/l hexafluorotitanic acid

2 g/l polyacrylic acid-vinyl phosphonate copolymer

2 g/l SiO₂ (as colloidal silica dispersion)

0.5 g/l citric acid

The silica dispersion contained particles having an average particle diameter measured by scanning electron microscopy in the range from around 8 to 20 nm.

### Example 3

### According to the Invention

Steel sheets were treated as described in Example 1, but with a composition that additionally contained a hydrolysed alkoxy silane as coupling reagent:

2 g/l hexafluorozirconic acid

2 g/l polyacrylic acid-vinyl phosphonate copolymer

2 g/l SiO₂ (as colloidal silica dispersion),

2.5 g/l aminopropyl trimethoxysilane (AMEO)

In order to produce the bath the silane compound was first hydrolysed in an acetic acid solution with stirring for several hours before the remaining constituents were added. A pH of 5 was then established.

### Example 4

### According to the Invention

Starting from a non-water-soluble polyethylene-acrylic acid copolymer a 25% stable aqueous dispersion was obtained by addition of a suitable amount of an ammonia solution at around 95° C. with stirring and reflux condensation. The dispersion thus obtained was used to produce a treatment solution with the following composition:

5 g/l polyethylene-acrylate copolymer (as aqueous dispersion)

2 g/l zirconium ammonium carbonate

10 g/l SiO₂ (as pyrogenic silica)

The pH of the treatment solution was adjusted to 8.5. Care was taken to ensure that the pH of the solution did not fall below 7.5 during production, otherwise the polymer or the pyrogenic silica could have been precipitated out. Care was also taken to ensure that the film was dried at a PMT of at least 80° C. Otherwise the steel strip was treated as described in Example 1.

### Example 5

### According to the Invention

In the same way as the steel sheets in the preceding examples, hot-dip galvanized (HDG) steel sheets with a zinc content of over 95% in the galvanized coating were cleaned, degreased and subjected to a surface treatment with the composition described below:

2 g/l hexafluorotitanic acid

1.8 g/l polyacrylic acid (molecular weight: approx. 100,000)

5 g/l SiO₂ (as pyrogenic silica)

The constituents were added to the aqueous solution or dispersion in the cited sequence.

### Example 6

### According to the Invention

Hot-dip galvanized steel sheets were treated in the same way as described in Example 5, but with a composition containing the inorganic particles in the form of a colloidal solution:

2 g/l hexafluorozirconic acid

1.8 g/l polyacrylic acid (molecular weight: approx. 100,000)

2 g/l SiO₂ (as colloidal silica dispersion)

The particles contained in the composition displayed an average particle diameter in the range from 12 to 16 nm.

### Example 7

### According to the Invention

Hot-dip galvanised steel sheets were treated in the same way as in Example 6, but with a treatment solution in which the content of inorganic particles was five times higher than in the composition described in Example 6:

2 g/l hexafluorozirconic acid

1.8 g/l polyacrylic acid (molecular weight: approx. 100,000)

10 g/l SiO₂ (as colloidal silica dispersion)

Increasing the particle concentration above the optimum values led to a deterioration primarily in the adhesion properties of a subsequently applied additional organic coating or lacquer film.

### Example 8

### According to the Invention

In a similar way as in Example 3 for steel surfaces, hot-dip galvanised steel sheets were treated with a composition that in addition to fluoro metallate, polymers and inorganic particles contained a silane hydrolysed in aqueous solution. The treatment solution consisted of the following constituents:

2 g/l hexafluorozirconic acid

1.8 g/l polyacrylic acid (molecular weight approx. 100,000)

4 g/l SiO₂ (as colloidal silica dispersion)

2.5 g/l 3-glycidyl oxypropyl trimethoxysilane (GLYMO)

For production the silane component was first hydrolysed in aqueous solution and the remaining constituents were then added.

### Example 9

### According to the Invention

In a similar way as in Example 4 according to the invention for steel surfaces, hot-dip galvanised steel sheets were coated with an alkalified treatment solution having a pH of 9, which displayed the following composition:

5 g/l polyethylene-acrylate copolymer (as aqueous dispersion)

2 g/l zirconium ammonium carbonate

4 g/l SiO₂ (as colloidal silica dispersion)

Here too the temperature of the metal surface during drying of the film was at least 80° C.

### Example 10

### According to the Invention

Hot-dip galvanised steel surfaces were treated according to the preceding example 9 with an alkaline composition having a pH of 9, which in addition to the polymer dispersion and the Zr component contained an aqueous dispersion of TiO₂ particles with an average particle size of 5 nm and was composed as follows:

5 g/l polyethylene-acrylate copolymer (as aqueous dispersion)

2 g/l zirconium ammonium carbonate

4 g/l TiO₂ (as aqueous dispersion)

### Example 11

### According to the Invention

Corresponding to Example 10 according to the invention, hot-dip galvanised steel surfaces were treated with a TiO₂-containing composition which in contrast to the preceding example displayed an acid pH of 3, however, and in addition to the titanium and zirconium compounds also contained aluminium ions.

3 g/l hexafluorozirconic acid

2 g/l hexafluorotitanic acid

0.3 g/l Al (OH)₃

2 g/l polyacrylic acid (molecular weight: approx. 100,000)

4 g/l TiO₂ (as aqueous dispersion)

The TiO₂-containing treatment solutions generally display still better corrosion protection properties in comparison to the SiO₂-containing compositions, especially on hot-dip galvanised surfaces. However, in comparison to the SiO₂-containing solutions these compositions display a markedly reduced storage stability.

### Example 12

### According to the Invention

Corresponding to Example 11 according to the invention, hot-dip galvanised steel sheets were treated with a composition that additionally contained manganese ions:

3 g/l hexafluorozirconic acid

2 g/l hexafluorotitanic acid

b 0.3 g/l Al(OH)₃

2 g/l polyacrylic acid (molecular weight: approx. 100,000)

4 g/l TiO₂ (as aqueous dispersion)

1 g/l MnCO₃

The addition of Mn to the treatment solution firstly improves-the anti-corrosive effect of the coating and in particular increases the resistance of the coating towards alkaline media such as e.g. the cleaning agents conventionally used in coil coating.

### Example 1

### Aaccording to the Invention

Corresponding to Example 12 according to the invention, hot-dip galvanised steel sheets were treated with a composition containing a colloidal silica dispersion in place of the TiO₂ dispersion:

3 g/l hexafluorozirconic acid

2 g/l hexafluorotitanic acid

0.3 g/l Al(OH)₃

2 g/l polyacrylic acid (molecular weight: approx. 100,000)

2 g/l SiO₂ (as colloidal silica dispersion)

1 g/l MnCO₃

The addition of Mn to the treatment solution firstly improves the anti-corrosive effect of the coating and in particular increases the resistance of the coating towards alkaline media such as e.g. the cleaning agents conventionally used in coil coating. Colloidal SiO₂ was added in place of the TiO₂ dispersion.

### Example 14

### According to the Invention

Corresponding to Example 14 according to the invention, hot-dip galvanised steel sheets were treated with a composition containing no hexafluorotitanic acid and a somewhat reduced amount of hexafluorozirconic acid and polyacrylic acid:

2 g/l hexafluorozirconic acid

0.3 g/l Al (OH)₃

1.8 g/l polyacrylic acid (molecular weight: approx. 100,000)

2 g/l SiO₂ (as colloidal silica dispersion)

1 g/l MnCO₃

The addition of Mn to the treatment solution firstly improves the anti-corrosive effect of the coating and in particular increases the resistance of the coating towards alkaline media such as e.g. the cleaning agents conventionally used in coil coating. In comparison to Example 13 the content of H2TiF6 was omitted and the amount of H2ZrF6 reduced. The lacquer adhesion was improved as a consequence.

### Example 15

### According to the Invention

Corresponding to Example 14 according to the invention, hot-dip galvanised steel sheets were treated with a composition containing no aluminium hydroxide:

2 g/l hexafluorozirconic acid

1.8 g/l polyacrylic acid (molecular weight: approx. 100,000)

2 g/l SiO₂ (as colloidal silica dispersion)

1 g/l MnCO₃

The addition of Mn to the treatment solution firstly improves the anti-corrosive effect of the coating and in particular increases the resistance of the coating towards alkaline media such as e.g. the cleaning agents conventionally used in coil coating. The pH was adjusted by addition of ammonia. In comparison to Example 14 the addition of aluminium hydroxide was omitted.

### Example 16

### According to the Invention

Starting from the composition in Example 9, the content of polyethylene acrylate was increased from 5 to 10 g/l. The coating according to the invention was formed more thickly as a consequence.

### Example 17

### According to the Invention

Corresponding to Example 16 according to the invention, an addition of 0.5 g/l polyethylene wax with a melting point in the range from 125 to 165° C. was also added to the composition in Example 16. The surface slip of the coating was significantly improved as a consequence.

### Example 18

### ccording to the Invention

1.0 g/l of the corrosion inhibitor diethyl thio urea was added to the aqueous composition according to the invention in Example 14, as a consequence of which the corrosion resistance was still further improved and a greater reliability for mass production achieved.

### Comparative Example 1

As the corrosion test results and assessments of lacquer adhesion tests generally depend very greatly on the lacquer system used and the specific test conditions, absolute values for such test results have only a limited significance. Therefore in the performance of the experiments described in the examples according to the invention comparable material samples were always coated using a chromating process corresponding to the prior art, which led to a chromium deposition of approx. 20 mg/m². To this end Gardobond® C4504 (Chemetall GmbH) in a bath concentration of 43 g/l of the commercial concentrate was applied in the same way as the aforementioned solutions, dried in a circulating air oven and then coated with coil-coating lacquers.

### Comparative Example 2

The inorganic compounds in particle form used in the process according to the invention are critical to the adhesion of a subsequently applied additional organic coating and to the corrosion properties of the composite comprising metal, pretreatment according to the invention and organic coating. As a comparative experiment steel surfaces were therefore treated with an aqueous composition that largely corresponded to the process according to the invention in terms of its constituents but which did not contain the important addition of inorganic particles. In detail, the composition contained:

2 g/l hexafluorotitanic acid

2 g/l polyacrylic acid/vinyl phosphonate copolymer

0.5 g/l citric acid

In comparison to the equivalent composition described in Example 2 according to the invention with the addition of a colloidal silica dispersion, the composition resulted in a significantly reduced corrosion protection.

### Comparative Example 3

Corresponding to comparative example 2 for steel surfaces, hot-dip galvanised steel sheets were treated with a composition that contained the constituents according to the invention but no inorganic compounds in particle form.

2 g/l hexafluorotitanic acid

1.8 g/l polyacrylic acid (molecular weight: approx. 100,000)

In comparison to the equivalent composition described in Example 6 according to the invention with the addition of a colloidal silica dispersion, the composition resulted in both a significantly reduced adhesion of a subsequently applied coil-coating lacquer and a significantly reduced corrosion protection.

### Comparative Example 4

The choice of a suitable organic film former in the form of water-soluble or water-dispersible polymers is likewise of critical importance to the anti-corrosive effect of the system and to the adhesion of a subsequently applied lacquer. Both the absence of the bath component and the choice of an unsuitable polymer compound have a considerable negative influence on corrosion protection and lacquer adhesion. An aqueous solution of a polyvinyl pyrrolidone supplied by BASF is cited as an example of a polymer system that is unsuitable within the context of the invention. The composition of the bath solution otherwise corresponded to the process according to the invention:

2 g/l hexafluorozirconic acid

2 g/l polyvinyl pyrrolidone (as aqueous solution)

2 g/l SiO₂ (as colloidal silica dispersion)

Hot-dip galvanised steel sheets treated with this composition displayed a markedly reduced lacquer adhesion and an inferior corrosion protection as compared with the comparable examples according to the invention. An adequate explanation has not yet been provided as to which factors on a molecular level make a polymer system suitable for use within the context of the invention. The polymer systems cited as being suitable in the examples according to the invention were determined by screening processes.

### Comparative Example 5

On aluminium surfaces in particular, pretreatment processes are also sometimes used that in addition to complex fluorides of zirconium or titanium contain no additional components such as organic film formers or inorganic particles. However, such processes do not provide adequate corrosion protection on zinc or iron surfaces. This can be verified by corrosion test results obtained on hot-dip galvanised steel surfaces following treatment with a composition containing hexafluorozircbnic acid as the sole constituent. The aqueous composition in this comparative example contained 2 g/l hexafluorozirconic acid.

Table 1 compares the compositions of the experimental baths cited in the examples. Table 2 summarises the results of the corrosion and lacquer adhesion tests on the coatings obtained with these compositions.

TABLE 1
Overview of the composition of examples and comparative examples.
“Polyacrylic” stands for polyacrylic acid, Zr(CO₃)₂ for a Zr
ammonium carbonate.

| | Zr, Ti, | c | | c | Inorg. | c | Addi- | c | |
|---|---|---|---|---|---|---|---|---|---|
| Ex | Cr | [g/l] | Polymer | [g/l] | particles | [g/l] | tives | [g/l] | pH |
| E1 | H₂ZrF₆, | 1.6 | Polyacrylic/ | 2.0 | Pyrogenic | 2 | Citric | 1.0 | 4.5 |
| | H₂TiF₆ | 0.8 | vinyl | | SiO₂ | | acid | | |
| | | | phosphonate | | | | | | |
| E2 | H₂TiF₆ | 2.0 | Polyacrylic/ | 2.0 | Colloidal | 2 | Citric | 0.5 | 4.5 |
| | | | vinyl | | SiO₂ | | acid | | |
| | | | phosphonate | | | | | | |
| E3 | H₂ZrF₆ | 2.0 | Polyacrylic/ | 2.0 | Colloidal | 2 | AMEO | 2.5 | 5 |
| | | | vinyl | | SiO₂ | | | | |
| | | | phosphonate | | | | | | |
| E4 | Zr(CO₃)₂ | 2.0 | Polyethylene/ | 5.0 | Pyrogenic | 10 | — | — | 8.5 |
| | | | acrylate | | SiO₂ | | | | |
| E5 | H₂TiF₆ | 2.0 | Polyacrylic | 1.8 | Pyrogenic | 5 | — | — | 2 |
| | | | | | SiO₂ | | | | |
| E6 | H₂ZrF₆ | 2.0 | Polyacrylic | 1.8 | Colloidal | 2 | — | — | 2 |
| | | | | | SiO₂ | | | | |
| E7 | H₂ZrF₆ | 2.0 | Polyacrylic | 1.8 | Colloidal | 10 | — | — | 2 |
| | | | | | SiO₂ | | | | |
| E8 | H₂TiF₆ | 2.0 | Polyacrylic | 1.8 | Colloidal | 4 | GLYMO | 2.5 | 5 |
| | | | | | SiO₂ | | | | |
| E9 | Zr(CO₃)₂ | 2.0 | Polyethylene/ | 5.0 | Colloidal | 4 | — | — | 9 |
| | | | acrylate | | SiO₂ | | | | |
| E10 | Zr(CO₃)₂ | 2.0 | Polyethylene/ | 5.0 | TiO₂ | 4 | — | — | 9 |
| | | | acrylate | | dispers. | | | | |
| E11 | H₂ZrF₆, | 3.0 | Polyacrylic | 2.0 | TiO₂ | 4 | Al(OH)₃ | 0.3 | 3 |
| | H₂TiF₆ | 2.0 | | | dispers. | | | | |
| E12 | H₂ZrF₆, | 3.0 | Polyacrylic | 2.0 | TiO₂ | 4 | Al(OH)₃ | 0.3 | 3 |
| | H₂TiF₆ | 2.0 | | | dispers. | | MnCO₃ | 1.0 | |
| E13 | H₂ZrF₆, | 3.0 | Polyacrylic | 2.0 | Colloidal | 2 | Al(OH)₃ | 0.3 | 3 |
| | H₂TiF₆ | 2.0 | | | SiO₂ | | MnCO₃ | 1.0 | |
| E14 | H₂ZrF₆ | 2.0 | Polyacrylic | 1.8 | Colloidal | 2 | Al(OH)₃ | 0.3 | 3 |
| | | | | | SiO₂ | | MnCO₃ | 1.0 | |
| E15 | H₂ZrF₆ | 2.0 | Polyacrylic | 1.8 | Colloidal | 2 | MnCO₃ | 1.0 | 3 |
| | | | | | SiO₂ | | | | |
| E16 | Zr(CO₃)₂ | 2.0 | Polyethylene/ | 10.0 | Colloidal | 4 | — | — | 9 |
| | | | acrylate | | SiO₂ | | | | |
| E17 | Zr(CO₃)₂ | 2.0 | Polyethylene/ | 10.0 | Colloidal | 4 | Poly- | 0.5 | 9 |
| | | | acrylate | | SiO₂ | | ethyl. | | |
| | | | | | | | wax | | |
| E18 | H₂ZrF₆ | 2.0 | Polyacrylic | 1.8 | Colloidal | 2 | Al(OH)₃ | 0.3 | 3 |
| | | | | | SiO₂ | | MnCO₃ | 1.0 | |
| | | | | | | | Diethyl | 1.0 | |
| | | | | | | | thio | | |
| | | | | | | | urea | | |
| C1 | Gardo- | 43 | — | — | — | — | — | — | 2 |
| | bond ® C | | | | | | | | |
| | 4504 | | | | | | | | |
| | (CrVI) | | | | | | | | |
| C2 | H₂TiF₆ | 2 | Polyacrylic/ | 2 | — | — | Citric | 0.5 | 4.5 |
| | | | vinyl | | | | acid | | |
| | | | phosphonate | | | | | | |
| C3 | H₂ZrF₆ | 2 | Polyacrylic | 1.8 | — | — | — | — | 2 |
| C4 | H₂ZrF₆ | 2 | Polyvinyl | 2 | Colloidal | 2 | — | — | 2 |
| | | | pyrrolidone | | SiO₂ | | | | |
| C5 | H₂ZrF₆ | 2 | — | — | — | — | — | — | 2 |

### Example 2

### Results of the Adhesion and Corrosion Protection Results

| | | Coating | | | Salt spray test | | VDA cyclic test | |
|---|---|---|---|---|---|---|---|---|
| | | weight for | | | (DIN 50021) U | | (VDA 621-415) U | |
| | | Zr or Ti | T-bend | Erichsen indent. | [mm] after 480 | | [mm] after 10 | |
| | Sub- | content | 1-T* | after cross- | h | | cycles | |
| Ex | strate | mg/m² | (peel in %) | hatching (peel in %) | Scratch | Edge | Scratch | Edge |
| E1 | Steel | 4.2, 1.4 | 5 | 0 | 5 | 4 | — | — |
| E2 | Steel | 3.5 | 1 | 0 | 3.5 | 4 | — | — |
| E3 | Steel | 5.3 | 5 | 2 | 3 | 4 | — | — |
| E4 | Steel | 5.2 | 5 | 1 | 2 | 3 | — | — |
| E5 | HDG | 3.5 | 5 | 2 | 1 | 2.5 | 2 | 3 |
| E6 | HDG | 5.3 | 2 | 0 | 0.5 | 2 | 1 | 2.5 |
| E7 | HDG | 5.3 | 10 | 2 | 0.5 | 1.5 | 1 | 2.5 |
| E8 | HDG | 3.5 | 1 | 0 | 1 | 2 | 1 | 2.5 |
| E9 | HDG | 5.1 | 2 | 0 | 1.5 | 2 | 1 | 2 |
| E10 | HDG | 5.3 | 2 | 1 | 1.5 | 2 | 1 | 1.5 |
| E11 | HDG | 7.9 3.5 | 10 | 1 | 1 | 1 | 0.5 | 1 |
| E12 | HDG | 7.9 3.5 | 5 | 1 | 0.5 | 1 | 0.5 | 1 |
| E13 | HDG | 7.9 3.5 | 5 | 1 | 1 | 1.5 | 0.5 | 1 |
| E14 | HDG | 5.3 | 1.5 | 1 | 0.5 | 0.75 | 0.5 | 0.5 |
| E15 | HDG | 5.3 | 2 | 1 | 0.5 | 1 | 0.5 | 1 |
| E16 | HDG | 5.3 | 5 | 1 | 1 | 1.5 | 0.5 | 1 |
| E17 | HDG | 5.1 | 5 | 1 | 1 | 1.5 | 0.5 | 1 |
| E18 | HDG | 5.3 | 1.5 | 1 | 0.5 | 0.5 | 0.5 | 0.5 |
| C1 | Steel | — | 0 | 0 | 0.5 | 0.5 | — | — |
| C1 | HDG | — | 2 | 1 | 0.5 | 1 | 0.5 | 0.5 |
| C2 | Steel | 3.5 | 60 | 8 | 7 | 5.5 | — | — |
| C3 | HDG | 3.5 | 70 | 10 | 6 | 7 | 3 | 4.5 |
| C4 | HDG | 5.3 | 80 | 15 | 4 | 7 | 2 | 2.5 |
| C5 | HDG | 5.3 | 60 | 6 | 3 | 5 | 2.5 | 4 |

Adhesion testing by means of the T-bend test was performed as defined in the NCCA standard, i.e. with a T-1 bend the gap between the bent halves of the metal sheet was approximately 1 mm, so that the bending diameter was around 1 mm. Following this extreme bending the lacquer adhesion was tested by means of adhesive tape tests and the result stated as the percentage of the surface affected by lacquer flaking and peel.

In the Erichsen adhesion test crosshatching was first applied to the lacquered metal surface and an Erichsen indentation of 8 mm then performed. Here too the lacquer adhesion was tested by means of adhesive tape tests and the result stated as the percentage of lacquer peel.

The results show that the treatment solutions according to the invention deliver comparable results to the chromating process used as reference in terms of the adhesion properties of a subsequently applied organic coating and the corrosion properties achievable with the coating structure. It is clear from the comparative examples that the properties of the coating primarily depend on the right choice of polymers and inorganic particles. The treatment process according to the invention can be used in both the mildly alkaline and acid pH range if suitable polymer systems are selected for the specific pH range.

In general terms it can be concluded from the cited examples that a better corrosion protection can generally be achieved with acid compositions in the pH range from 1 to 5 than with alkaline compositions. Mildly alkaline treatment solutions can however be advantageous if steel surfaces or pre-phosphated surfaces are to be treated, for which a pickling attack is to be kept as low as possible. The inorganic particles that are used in the treatment solutions ideally display a particle diameter in the range from 5 to 30 nm. Colloidal silica solutions are preferable to the corresponding powdered products of pyrogenic silica since they generally produce better adhesion properties. This is probably attributable to the considerably broader particle size distribution in the pyrogenic products. It was surprising that it was possible to develop a coating for hot-dip galvanised steel that is at least equal to a typical chromate pretreatment.

Although the coatings in the examples according to the invention only displayed a film thickness in the range from 0.01 to 0.2 μm, mostly in the range from 0.02 or 0.03 to 0.1 μm, these coatings were of outstanding quality.

1-41. (canceled)

41. A process contacting a metallic surface with an aqueous composition to form a particle containing film on said metallic surface; drying the film on said surface and optionally curing said film, wherein said aqueous composition is substantially or entirely free from chromium (VI) compounds and compises:
a) at least one organic film former containing at least one polymer that is soluble in water or dispersed in water and comprises a synthetic resin based upon polyacrylic acid, polyacrylate or polyethylene acrylic acid, or a synthetic resin blend having a content of a synthetic resin, or a mixed polymer having a content of a synthetic resin, wherein the synthetic resin is based upon acrylate or polyacrylate, wherein the total content of organic film former being in the range from 0.2 to 30 g/l,
b) a content of cations or hexafluoro complexes of cations selected from the group consisting of titanium, zirconium, hafmium, silicon and boron in the range from 0.1 to 50 g/l,
c) at least one inorganic compound in particle form with an average particle diameter measured with a scanning electron microscope ranging from 0.006 to 0.15 μm in diameter, the total content of these inorganic compounds being in the range from 0.2 to 25 g/l,
d) optionally at least one silane or siloxane calculated as silane and
e) optionally at least one corrosion inhibitor, and water;
wherein the ratio of the content of cations or hexafluoro complexes of cations b) to the content of inorganic compounds in particle form c) in the aqueous composition is ≦5.5:1,
wherein the aqueous composition is dried and optionally cured to form the particle containing film on said metallic surface and the film has a thickness in the range from 0.01 to 0.5 μm.

43. A process according to claim 42, wherein said metallic surface comprises a metal or metal alloy selected from the group consisting of aluminum, iron, copper, magnesium, nickel, titanium, tin, zinc, an aluminum alloy, an iron alloy, a copper alloy, a magnesium alloy, a nickel alloy, a titanium alloy, a tin alloy and a zinc alloy.

44. A process according to claim 42, wherein the organic film former is present in the form of a solution, dispersion, emulsion, micro-emulsion or suspension.

45. A process according to claim 42, wherein the organic film former is at least one synthetic resin.

46. A process according to claim 42, wherein the organic film former is a synthetic resin blend or mixed polymer containing an amount of synthetic resin selected from the group consisting of an acrylate, a polyacrylate, ethylene, polyethylene, urea-formaldehyde, polyurethane, polystyrene and styrene, from which during or after release of water and other volatile components an organic film is formed.

47. A process according to claim 42, wherein the organic film former contains a synthetic resin, polymer, derivative, copolymer, mixture, copolymers, polymers, mixtures or a mixed polymer comprising at least one or acrylate, polyacrylic polethyleneimine, polyurethane, polyvinyl alcohol, polyvinyl phenol, polyvinyl pyrrolidone or polyaspartic acid.

48. A process according to claim 42, wherein the acid value of the synthetic resin ranges from 5 to 250.

49. A process according to claim 42, wherein the acid value of the synthetic resin ranges from 5 to 250.

50. A process according to claim 42, wherein the pH of the organic film former in an aqueous preparation without addition of other compounds is in the range from 1 to 12.

51. A process according to claim 42, wherein the organic film former contains only water-solulble synthetic resins or polymers, stable in a solution having a pH<5.

52. A process according to claim 42, wherein the organic film former further conmprises synthetic resin or polymer that display carboxyl groups.

53. A process according to claim 42, wherein an acid group in the synthetic resin is stabilized with ammonia, an amine, or with alkali-metal compound.

54. A process according to claim 42, wherein the aqueous composition contains 0.5 to 10 g/l of the organic film former.

55. A process according to claim 42, wherein the aqueous composition contains 0.2 to 30 g/l of cations or hexafluoro complexes of cations selected from the group consisting of titanium, zirconium, hafnium, silicon, aluminum and boron.

56. A process according to claim 42, wherein Mn ions in an amount ranging from 0.05 to 10 g/l are added to the aqueous composition.

57. A process according to claim 42, wherein the content of at least one silane or siloxane calculated as silane in the aqueous composition is preferably 0.1 to 50 g/l.

58. A process according to claim 42, wherein the aqueous composition contains at least one partially hydrolyzed or entirely hydrolyzed silane.

59. A process according to claim 42, wherein at least one amino silane, an epoxy silane, a vinyl silane or at least one corresponding siloxane is included.

60. A process according to claim 42, wherein said inorganic compound is in the form of a finely dispersed powder, a dispersion or a suspension.

61. A process according to claim 42, wherein particles having an average particle size ranging from 8 nm to 150 nm are used as the inorganic compound in particle form.

62. A process according to claim 42, wherein particles based upon at least one compound of aluminum, barium, cerium, a rare-earth element, calcium, lanthanum, silicon, titanium, yttrium, zinc or zirconium are added as the inorganic compound in particle form.

63. A process according to claim 42, wherein particles based upon aluminum oxide, barium sulfate, cerium dioxide, rare-earth mixed oxide, silicon dioxide, silicate, titanium oxide, yttrium oxide, zinc oxide or zirconium oxide are added as the inorganic compound in particle form.

64. A process according to claim 42, wherein the aqueous composition contains 0.5 to 10 g/l of the at least one inorganic compound in particle form.

65. A process according to claim 64, wherein a solvent is provided and said solvent comprises at least one compound selected from the group consisting of a water-miscible alcohol, a water-soluble alcohol, a glycol ether and N-methyl pyrrolidone.

66. A process according to claim 41, wherein the composition has an organic solvent content of 0.1 to 10 wt. %.

67. A process according to claim 42, wherein an organic compound or an ammonium compound is added as corrosion inhibitor.

68. A process according to claim 42, wherein at least one wax selected from the group consisting of paraffins, polyethylenes and polypropylenes is added as a lubricant.

69. A process according to claim 68, wherein the melting point of the wax used as lubricant is in the range from 40 to 160° C.

70. A process according to claim 42, wherein the aqueous composition optionally contains at least one each of a biocide, a defoaming agent or a wetting agent.

71. A process according to claim 42, wherein the aqueous composition has a pH in the range from 0.5 to 12.

72. A process according to claim 42, wherein the aqueous composition is applied to the metallic surface at a temperature in the range from 5 to 50° C.

73. A process according to claim 42, wherein the metallic surface is kept at temperatures in the range from 5 to 120° C. when contracted with the composition.

74. A process according to claim 42, wherein the metallic surface with the applied aqueous composition is dried at a temperature in the range from 20 to 400° C. to form a film.

75. A process according to claim 42, wherein the metallic surface is on a metal strip and the strip having the film thereon is wound into a coil after drying or optionally curing.

76. A process according to claim 42, wherein a coil-coating lacquer together with a topcoat lacquer applied to the dried or cured film results in an adhesive strength of a maximum of 10% of the surface peeled away in a T=bend test with a 1-T bend accordin gto NCCA.

77. A process according to claim 42, wherein the aqueous composition is applied by rolling, flow-coating, knife application, spraying, atomization, brushing or immersion and optionally by subsequent squeezing with a roller.

78. A process according to claim 42, wherein at least one coating consisting of lacquer, polymers, paint, adhesive or adhesive support is applied to the film.

79. A process according to claim 42, wherein the metallic surface having the film thereon is formed, lacquered, coated with a polymer, printed, glued, hot-soldered, welded or joined to another said metallic surface or to other structural elements.

80. An aqueous composition for the pretreatment of a metallic surface prior to an additional coating or for the treatment of that surface, wherein the composition is substantially or entirely free of chromium (IV) compounds and consists essentially of water and
a) at least one organic film former containing at least one polymer that is soluble in water or dispersed in water and that is a synthetic resin based upon polyacrylic acid, polyacrylate or polyethylene acrylic acid or a synthetic resin blend or a mixed polymer with a content of synthetic resin based upon acrylate or polyacrylic, the total content of organic film former being in the range from 0.2 to 30 g/l,
b) a content of cations or hexafluoro complexes of cations selected from the group comprising titanium, zirconium, hafnium, silicon and boron in the range from 0.1 to 50 g/l,
c) at least one inorganic compound in particle form with an average particle diameter measured with a scanning electron microscope ranging from 0.005 to 0.2 microns in diameter, the total content of these inorganic compounds being in the range from 0.2 to 25 g/l,
d) at least one silane or siloxane calculated as silane and
e) at least one corrosion inhibitor and whereby the ratio of the content of cations or hexafluoro complexes of cations b) to the content of inorganic compounds in particle form c) is <5.5:1.

81. The process of claim 42, wherein the metallic surface is a ware, a wire winding, a wire mesh, a steel strip, a metal sheet, a panel, a screen, a vehicle body or part of a vehicle body, a part of a vehicle, trailer, motor caravan or airborne vehicle, a cover, a housing, a lamp, a light, a traffic signal element, a piece of furniture or furniture element, an element of a household appliance, a frame, a profile, a molding having a complex geometry, a crash barrier, heater or fencing element, a bumper, a part comprising at least one pipe or profile, a window, door, bicycle frame, or a small part.

82. A process according to claim 42, wherein the organic film former is present in the form of a solution, dispersion, emulsion, micro-emulsion or suspension.

83. A coated metallic surface prepared according to the process of claim 81.

84. A process according to claim 42, further comprising applying an additional coat different from said aqueous composition, or of said aqueous composition.

85. A process according to claim 42, wherein said metallic surface is on a strip or section of a strip.

86. A process according to claim 84, wherein said metallic surface is on a strip or section of a strip.

87. A process according to claim 84, further comprising forming the metallic surface having the film thereon into a desired shape.

88. A process according to claim 86, further comprising forming the metallic surface having the film thereon into a desired shape.

89. A process according to claim 45, wherein said synthetic resin comprises at least one of acrylate, ethylene, polyester, polyurethane silicone, polyester, epoxy, phenol, styrene, urea-formaldehyde, a derivative thereof, a copolymer thereof, a mixture thereof or a mixed polymer thereof.

90. A process according to claim 42, wherein said metallic surface is clean.

91. A process according to claim 42, wherein said organic film former is a copolymer with a phosphorous-containing compound.

92. A process according to claim 49, wherein said organic film former is a copolymer with a phosphorous-containing compound.

93. A process according to claim 53, wherein said amine is morpholine, dimethyl ethanolanine, or triethanolamine.

94. A process according to claim 53, wherein said alkali-metal compound is sodium hydroxide.

95. A process according to claim 42, wherein water is added as a solvent.

96. A process according to claim 42, wherein a solvent is added to the aqueous composition, and wherein said solvent is a blend of the water and at least one alcohol, an ester alcohol, a glycol ether or butanediol.

97. A process according to claim 42, wherein the content of each of a), b) and c) is from 0.5 to 10 g/L.
